(19) United States
(12) Patent Application Publication
(10) Pub. No.: US 2024/0196343 A1
(43) Pub. Date: Jun. 13, 2024

(54) MOBILE RADIO TERMINAL DEVICE, COMMUNICATION DEVICE FOR CONFIGURING A MOBILE RADIO TERMINAL DEVICE, AND METHODS FOR CONFIGURING A MOBILE RADIO TERMINAL DEVICE

(71) Applicant: Intel Corporation, Santa Clara, CA (US)

(72) Inventors: Sajal Kumar DAS, Bangalore (IN); Madhukiran SRINIVASAREDDY, Bangalore (IN); Jayprakash THAKUR, Bangalore (IN); Maruti TAMRAKAR, Chhattisgarh (IN); Mallari HANCHATE, Bangalore (IN); Vamshi Krishna AAGIRU, Bangalore (IN); Abhijith PRABHA, Piravom (IN); Sagar GUPTA, Pradesh (IN); Mythili HEGDE, Bangalore (IN)

(21) Appl. No.: 18/063,091

(22) Filed: Dec. 8, 2022

(51) Int. Cl. H04W 52/36; H04L 1/00; H04W 52/28

(52) U.S. Cl. CPC H04W 52/367; H04L 1/0003; H04W 52/283

(57) ABSTRACT

A mobile radio terminal device may include a processor configured to receive information that one or more antennas of the mobile radio terminal device are in proximity of a human body part of a user of the mobile radio terminal device, modify a transmission configuration of the mobile radio terminal device based on the received information, and generate a message representing the changed transmission configuration.

### TECHNICAL FIELD

Various aspects of this disclosure generally relate to devices and methods for configuring a mobile radio terminal device, and to devices and methods for determining a transmission configuration of the mobile radio terminal device.

### BACKGROUND

With the advent of advancement of communication technology and a strong demand for an always-connected type of experience, terminal user devices such as laptops, tablets and smart phones are increasingly housing cellular modems (which are 4G or 5G capable). However, in the Radio Frequency, RF, range, the radiation coming out from the radio transmitter of these terminal user devices can affect the human health. Therefore, cellular enabled connected devices are required to meet RF exposure limits set by regulatory bodies.

The Federal Communications Commision, FCC, in the United States requires the Specific Absorption Rate, SAR, (which is a measure of the rate of RF energy absorption per unit mass by the human body) to be under 1.6 Watt per kilogram (1.6 W/kg). In the EU, the International Electrotechnical Commission requires the SAR to be under 2 W/kg, and in India the Department of Telecommunications requires the SAR to be under 1.6 W/kg.

A mobile radio terminal device has to always ensure that the safety criterias for RF exposure are met. Therefore, when a human body part of the user comes in close contact with a Transmission, Tx, antenna of a mobile radio terminal device, such as e.g. a smart phone, a tablet or a laptop, the Tx power of the antenna is reduced for SAR safety. This reduction in Tx power combined with the obstruction of the antenna by a human body part causes a strong degradation of the communication and link quality from that Tx antenna.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. It should be understood that the drawings are diagrammatic and schematic representations of exemplary aspects of the invention, and are neither limitative nor necessarily drawn to scale of the present invention. In the following description, various embodiments of the invention are described with reference to the following drawings, in which:

FIG. 1 shows an exemplary radio communication network;

FIG. 2 shows an exemplary radio communication network including a terminal device operating in 2×2 MIMO mode;

FIG. 3 shows exemplary interactions between a base station and a terminal device in a SAR limiting scenario;

FIG. 4 shows diversity reception modes;

FIG. 5 shows an exemplary flowchart of a method to configure a terminal device in a SAR limiting scenario according to some aspects;

FIG. 6 shows an exemplary mobile radio terminal device according to some aspects;

FIG. 7 shows an exemplary communication device according to some aspects;

FIG. 8 shows a flowchart illustrating a method of configuring a mobile radio terminal device for a device according to some aspects; and

FIG. 9 shows a flowchart illustrating a method of configuring a mobile radio terminal device by a communication device according to some aspects.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The phrases “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The phrases “proper subset”, “adjust subset”, and “lesser subset” refer to a subset of a set that is not equal to the set, illustratively, referring to a subset of a set that contains less elements than the set.

The phrase “at least one of” with regard to a group of elements may be used herein to mean at least one element from the group including the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit, and may also be referred to as a “processing circuit,” “processing circuitry,” among others. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality, among others, and conversely that any single processor, controller, or logic circuit detailed herein may be realized as two (or more) separate entities with equivalent functionality, among others.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

The term “terminal device” utilized herein refers to user-side devices (both portable and fixed) that can connect to a core network and/or external data networks via a radio access network. “Terminal device” can include any mobile or immobile wireless communication device, including User Equipments (UEs), Mobile Stations (MSs), Stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. For purposes of this disclosure, radio communication technologies may be classified as Cellular Wide Area radio communication technology. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax), 5G New Radio (NR), for example, and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions.

The term “calculate” encompass both ‘direct’ calculations via a mathematical expression/formula/relationship and ‘indirect’ calculations via lookup or hash tables and other array indexing or searching operations. The term “determine” encompass both ‘direct’ determinations via a mathematical expression/formula/relationship and ‘indirect’ determinations via lookup or hash tables and other array indexing or searching operations.

When the Tx power of an antenna of a terminal device is changed for SAR safety, and it is additionally obstructed by a human body part, the radio communication link quality may be significantly lowered. This causes an increase in the Bit Error Rate, BER and the Block Error Rate, BLER. The radio communication link may even become so poor that it is interrupted, e.g. an ongoing call is dropped.

If the transmission configuration of the terminal device remains unchanged while the Tx power of one or more of its antennas is reduced, data throughput and reception quality may be poor. A poor communication link also means that more retransmissions are necessary, and that latency/delays will increase. Severe degradation of the communication link may even cause it to be broken. Furthermore, if the network/base station (e.g. eNB, gNB) serving the terminal device is not quickly made aware of the reduction in Tx power, channel resources will be wasted. Lastly, on the side of the terminal device, battery consumption may be higher than needed due to operating in a transmission configuration that is battery intensive, such as e.g. Multiple-Input-Multiple-Output, MIMO, mode.

Currently, a terminal device does not communicate to a serving radio communication network that one or more of its Tx antenna(s) are operating at a changed (reduced) Tx power due to being in a so-called “SAR limiting scenario”, i.e. due to a human body part of the user being in the proximity of one or more Tx antenna(s) of the terminal device. The radio communication network therefore continues with an earlier configured transmission mode, e.g. MIMO mode, and a higher Modulation and Coding Scheme, MCS, until the lowered transmission (Tx) power is detected. This detection usually occurs by using an averaging algorithm in the channel estimation unit of the network receiver. However, this type of detection by the network takes a long time, and by then, the communication link quality may have already strongly deteriorated. The communication link may even be broken (e.g. an ongoing call may have been interrupted). All of this results in a poor user experience.

In the following examples and embodiments, the expression “SAR limiting scenario” is used to indicate that one or more antennas of a terminal device are in the proximity of a human body and that the obstructed antennas have adjusted their Tx power in accordance with SAR regulations. Further, in the following, the terms base station and network are used interchangeably.

Various aspects of this disclosure provide efficient methods and devices for informing a radio communication network/base station that a terminal device is in a SAR limiting scenario. Various aspects of this disclosure further provide efficient methods and devices to determine (on the network side) the best transmission configuration for a terminal device in a SAR limiting scenario, and to instruct the terminal device to switch to the determined transmission configuration. This enables to achieve a higher (optimum) data throughput and a higher communication link quality when a terminal device is in a SAR limiting scenario.

As a first example, when a human body part of a user, e.g. a hand of the user, is in proximity of a transmitter antenna of a terminal device, the device detects this and adjusts the Tx power of the obstructed transmitter antenna in order to comply with SAR regulations. The adjustment in Tx power depends on several factors, such as e.g. how close the human body part of the user is to the antenna, the current transmit power of the antenna and the current transmission configuration (transmission mode and MCS) of the terminal device. The terminal device then communicates to the network that one or more of its transmitter antennas are operating at a changed (reduced) Tx power. This information may be sent directly to the network, e.g. by sending a dedicated message including the information, or indirectly, by sending the information in already existing messages (regularly) sent to the network, e.g. by using unused bits/fields in existing messages and/or by changing certain parameter values in the message fields. The network is thus quickly made aware that the terminal device is in a SAR limiting scenario, and receives information indicating which antennas are currently obstructed, and their corresponding Tx power level (and/or by how much the Tx power has been changed/reduced). With this information, the network evaluates the best suited (optimum) transmission configuration for the terminal device. For example, the network evaluates different n₁×n₂ MIMO modes (where n₁ denotes the number of Tx antennas and n₂ denotes the number of Rx antennas), asymmetrical MIMO modes, Tx Rx diversity modes, single antenna mode, as well as different modulation and coding schemes for each transmission mode. The determination is for example based on the performance/power gain for each transmission configuration, i.e. the network selects the transmission configuration best suited (best performance/power gains) for the current scenario. The network then instructs the terminal device to switch to the determined transmission configuration. This enables to increase the data throughput, increase the radio link quality, lower the BER and BLER, and to lower the number of required retransmissions when a terminal device is in a SAR limiting scenario.

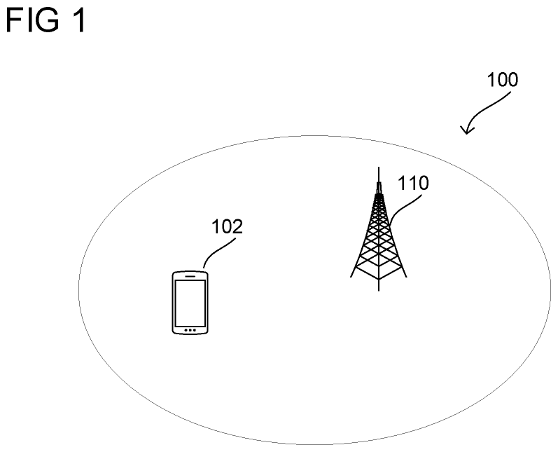

FIG. 1 depicts a general communication network and device architecture for wireless communications. FIG. 1 shows an exemplary radio communication network 100 according to some aspects, terminal device 102 and network access node 110. A terminal device 102 may typically include a plurality of antennas (not shown) to be used for communicating with radio communication network 100. Radio communication network 100 may communicate with terminal device 102 via network access node 110 over a radio access network. A network access node 110 may typically include a plurality of antennas (not shown) to be used for communicating with a terminal device 102. Although certain examples described herein may refer to a particular radio access network context, these examples are demonstrative and may therefore be readily applied to any other type or configuration of radio access network. The number of network access nodes and terminal devices in radio communication network 100 is exemplary and is scalable to any amount.

In an exemplary cellular context, network access node 110 may be a base station (e.g., gNodeB, eNodeB, NodeB, Base Transceiver Stations (BTSs), or any other type of base station). Terminal device 102 may be a cellular terminal device (e.g., Mobile Stations (MSs), User Equipments (UEs), or any type of cellular terminal device). Network access node 110 may interface (e.g., via backhaul interfaces) with a cellular core network such as an 5G Core (5 GC, for 5G), Evolved Packet Core (EPC, for LTE), Core Network (CN, for UMTS), or other (cellular) core networks, which may also be considered part of radio communication network 100. The cellular core network may interface with one or more external data networks.

Network access node 110 (and, optionally, other network access nodes of radio communication network 100 not explicitly shown in FIG. 1) may accordingly provide a radio access network to terminal device 102 (and, optionally, other terminal devices of radio communication network 100 not explicitly shown in FIG. 1). In an exemplary cellular context, the radio access network provided by network access node 110 may enable terminal device 102 to wirelessly access the core network via radio communications. The core network may provide switching, routing, and transmission, for traffic data related to terminal device 102, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data).

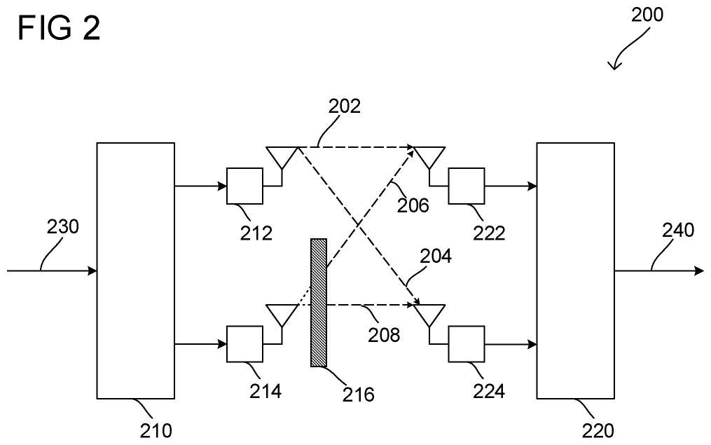

FIG. 2 illustrates an exemplary radio communication network 200 with a terminal device 210 operating in 2×2 MIMO mode and a network access node 220.

Terminal device 210 may be a terminal device such as terminal device 102, and comprises two transmitter antennas, a first transmitter antenna 212, and a second transmitter antenna 214. Network access node 220 may be a network access node such as network access node 110. Network access node 220 may be a base station, e.g. a gNodeB, eNodeB or NodeB. In the example of FIG. 2, an input data stream 230 is processed by terminal device 210 and transmitted by transmitter antennas 212 and 214. Network access node 220 comprises two receiver antennas, a first receiver antenna 222, and a second receiver antenna 224. The two transmitter antennas 212 and 214 communicate with the two receiver antennas 222 and 224 via wireless channels 202, 204, 206 and 208. After having processed the received information, the network access node 220 outputs data stream 240.

In the example of FIG. 2, the second transmitter antenna 214 is obstructed by a human hand 216. The terminal device, in order to comply with SAR regulations therefore reduces the Tx power of the second transmitter antenna 214 by an amount of X dB. Because of the Tx power reduction in antenna 214 and of the signal obstruction caused by the human hand, the Tx signal power from antenna 214 is significantly reduced.

Let the signal received at network access node 220 be denoted as:

$$y = hX + n$$

where h represents the channel gain and n is a noise component.

A 2×2 MIMO channel can then be represented in matrix notation as:

$$( \begin{matrix}{y}_{1} \\ {y}_{2}\end{matrix} ) = ( \begin{matrix}{h}_{1 , 1} & {h}_{1 , 2} \\ {h}_{2 , 1} & {h}_{2 , 2}\end{matrix} ) ( \begin{matrix}{x}_{1} \\ {x}_{2}\end{matrix} ) + ( \begin{matrix}{n}_{1} \\ {n}_{2}\end{matrix} )$$

With the above notation, the signal received at the first receiver antenna 222 of the network access node 220 is:

$${y}_{1} = {h}_{1 , 1} {x}_{1} + {h}_{1 , 2} {x}_{2} + {n}_{1} = ( \begin{matrix}{h}_{1 , 1} & {h}_{1 , 2}\end{matrix} ) ( \begin{matrix}{x}_{1} \\ {x}_{2}\end{matrix} ) + {n}_{1}$$

where h_{1,1} denotes the channel gain of the path between the first transmitter antenna 212 of terminal device 210 and the first receive antenna 222 of network access node 220 (the path corresponding to wireless channel 202), and n₁ is a first noise component. Analogously to h_{1,1}, h_{1,2}, h_{2,1} and h_{2,2} denote the channel gains of the corresponding paths between the transmitter antennas of the terminal device and the receiver antennas of the network access node.

Similarly to y₁, the signal received at the second receiver antenna 224 of the network access node is:

$${y}_{2} = {h}_{2 , 1} {x}_{1} + {h}_{2 , 2} {x}_{2} + {n}_{2} = ( \begin{matrix}{h}_{2 , 1} & {h}_{2 , 2}\end{matrix} ) ( \begin{matrix}{x}_{1} \\ {x}_{2}\end{matrix} ) + {n}_{2}$$

where h_{2,1} denotes the channel gain of the path between the second transmitter antenna 214 of terminal device 210 and the first receiver antenna 222 of network access node 220 (the path corresponding to wireless channel 206), and n₂ is a second noise component. As can clearly be seen from the above equation, when channel gains h_{2,1} and/or h_{2,2} are low (significantly reduced), the received signal y₂ will have a high decoding error.

Typically, in a 2×2 MIMO operation mode, a high(er) MCS is used. A higher order modulation means using lower redundant channel coding, e.g. lower channel error protection. A higher MCS thus further reduces the decoding quality of the received signal y₂.

In the example of FIG. 2, terminal device 210 is aware of the SAR limiting scenario, however the network is not aware of the issue. There is no message exchange between terminal device 210 and network access node 220 concerning the Tx power reduction of transmitting antenna 214 due to SAR safety. Therefore, the network receiver continues with the current 2×2 MIMO and MCS configuration until it discovers the issue (usually because after a certain time an averaging process running in the network channel estimation unit notices that the y₂ data stream decoding is poor).

Failing to quickly adjust the transmission configuration of terminal device 210 leads to a high BLER, which leads to more retransmissions and hence to more delay, resulting in a poor user experience. A further consequence is a higher power (battery) consumption of the device and of the network receivers. If the transmission configuration is not quickly adapted to the new scenario, the radio link between terminal device 210 and network access node 220 may even be interrupted, e.g. an ongoing call may be interrupted. More generally, a similar situation as the one illustrated by FIG. 2 may arise in the case of a n₁×n₂ MIMO configuration, where n₁ denotes the number of Tx antennas at a terminal device (transmitter antennas), and n₂ denotes the number of Rx antennas at a network access node (receiver antennas).

In the following, exemplary methods and devices to the problem occurring when the Tx power of one or more antennas of a terminal device are adjusted due to SAR safety are provided.

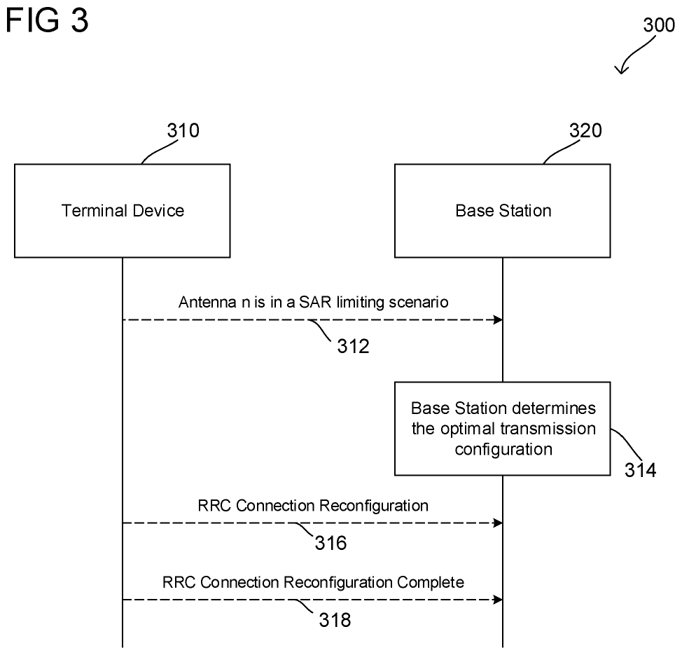

FIG. 3 shows exemplary interactions 300 between a base station 320 and a terminal device 310 when the terminal device is in a SAR limiting scenario. Terminal device 310 comprises several Tx antennas and may be a terminal device such as terminal device 102 or terminal device 210. Base station 320 may be a network access node such as network access node 110 and network access node 220. Base station 320 may e.g. be a gNB or an eNB.

The terminal device 310 detects that a transmitter antenna n is in a SAR limiting scenario. The terminal device therefore adjusts the Tx power value of antenna n in accordance with SAR regulations.

After detecting that transmitter antenna n is in a SAR limiting scenario, the terminal device 310 sends a notification 312 to base station 320. Notification 312 contains information indicating to base station 320 that transmitter antenna n is currently operating at a changed Tx power and/or is in a SAR limiting scenario, and, optionally, that its Tx power level has been changed by X dB. Notification 312 may include further information, e.g. it may include the current Tx power level of antenna n, the maximum Tx power of antenna n, etc. More generally, the message sent to the network may include the number of antennas currently in a SAR limiting scenario, information identifying each affected antenna, the current Tx power level of each affected antenna and/or their Tx power reduction value (compared to a maximum/usual Tx power value).

The notification 312 can be sent directly to base station 320, e.g. via a dedicated (control) message. The dedicated message includes information indicating that the terminal device is in a SAR limiting scenario, e.g. the message may contain the total number of affected antennas, and information identifying each affected antenna as well as their corresponding Tx power reduction value (compared to a maximum/usual Tx power value).

The notification 312 may for example have the following form:

(UE_SAR,Tx_reduction,n₁, . . . ,nₘ)

wherein n₁, . . . , nₘ indicate the antenna numbers (more than one antenna can be obstructed) and Tx_reduction indicates the transmit power reduction in dB. Tx_reduction may indicate the reduction in dB compared to a maximum/usual and/or last communicated Tx power level. Further, Tx_reduction may be the same value for each affected antenna or may indicate a differing value for one or more (and/or for each) of the affected antennas.

Alternatively, notification 312 may be sent indirectly to base station 320 by using an already existing message regularly sent to the base station. For example, terminal device 310 may modify the content (parameters) of an existing control message that is regularly sent to the network. The terminal device may e.g. use the Uplink Control Information, UCI, message that is sent using the PUCCH or PUSCH channels in 5G/LTE. The UCI comprises several fields with information indicating the channel quality, such as the CQI (Channel Quality Indicator), RI (Rank Indicator) or CSI (Channel Status Information). Terminal device 310 may thus notify the network that it currently is in a SAR limiting scenario by using unused bits/fields in the UCI message and/or by changing the value of certain fields/parameters, e.g. of the CQI. For example, an indirect message informing the network about the SAR limiting scenario may be a UCI message with a low CQI value, e.g. CQI=1 or a default value.

Once base station 320 receives notification 312, it is aware that terminal device 310 is currently in a SAR limiting scenario. In 314, the base station then analyzes and evaluates the different configuration options for terminal device 310 and determines the best suited (optimal) transmission configuration for the current scenario, e.g. the transmission configuration with the highest performance and/or power gains. The determined transmission configuration typically includes at least a transmission mode and a modulation and coding scheme (and optionally the Tx power).

After the determination, base station 320 instructs via a notification 316 (e.g. via an RRC Connection Reconfiguration message) terminal device 310 to switch to the determined transmission configuration.

Optionally, the terminal device, after having reconfigured as instructed sends a notification 318 to the base station 320 (e.g. an RRC Connection Reconfiguration Complete message) that it has successfully reconfigured as instructed.

Several of the possibilities for the transmission configurations of the terminal device are discussed in the following.

Table 1 below shows examples of different transmission modes used in LTE, in accordance with the transmission modes defined in 3GPP Specification 36.213, Table 7.2.3-0. [Dear inventors: Could you insert a reasonable version of the standard here, please? Thank you very much for your help!]

TABLE 1
Different transmission modes in LTE

| Transmission | |
|---|---|
| mode | Transmission scheme of PDSCH |
| 1 | Single-antenna port, port 0 |
| 2 | Transmit diversity |
| 3 | Transmit diversity if the associated rank indicator is 1, |
| | otherwise large delay CDD (cyclic delay diversity) |
| 4 | Closed-loop spatial multiplexing |
| 5 | Multi-user MIMO |
| 6 | Closed-loop spatial multiplexing with a single |
| | transmission layer |
| 7 | If the number of PBCH antenna ports is one, Single- |
| | antenna port, port 0; otherwise Transmit diversity |

It should be noted that the determination of the best suited (optimal) transmission configuration (transmission mode and MCS) does not require 3GPP standardization, and will typically be an algorithm implemented in the physical layer or data link layer of the network side. A network side algorithm will compute the performance/power gain for each of the transmission configuration options and determine the best suitable configuration to achieve the highest performance/power gains.

In the following examples, it is assumed that the terminal device includes several Tx antennas, and is configured to operate in MIMO mode when it is not in a SAR limiting scenario, e.g. 2×2, 4×4 or 8×8 MIMO. Although the examples described hereafter refer to a terminal device operating in MIMO mode when not in a SAR limiting scenario, these examples are demonstrative and may therefore be readily applied to any other type or configuration of the terminal device.

A first exemplary option for the transmission configuration is to continue in MIMO mode, for example because the reduction in Tx power of the one or more obstructed antennas is not large, e.g. is less than 1, 2 or 3 dB. In this case, only the MCS may be adjusted, and the terminal device instructed to change the MCS accordingly. The network may however also instruct the terminal device to change MIMO mode, e.g. the device may be instructed by the network to switch from 8×8 MIMO to 4×4 MIMO.

A second exemplary option for the transmission configuration is to continue in MIMO mode, but with asymmetrically redistributed Tx power. Returning to the example of FIG. 2, where the terminal device is operating in 2×2 MIMO mode and one of the transmitter antennas is obstructed by a human hand. As can be seen in FIG. 2, the first transmitter antenna 212 is not obstructed/not in the proximity of a human body part of the user. A possibility for the new transmission mode of terminal device 210 is therefore to increase the Tx power of transmitter antenna 212 by the same amount (X) of dB than antenna 214 has been reduced. This means that overall, the Tx power of terminal device 210 remains the same, and is redistributed among the transmitting antennas. In such case, terminal device 210 is said to be operating in an asymmetrical 2×2 MIMO mode. If the Tx power of transmitter antenna 212 is increased, the data rate in its data stream (channels 202 and 204) should also be increased. This can be achieved by using a higher order MCS for the first data stream (and/or using a higher modulation order and/or a lower coding rate). On the other hand, the data rate in the second stream (channels 206 and 208) should be reduced due to the Tx power reduction of transmitter antenna 214. This can for example be achieved by using a lower MCS (and/or lower order modulation and/or higher coding rate). The network may be configured to evaluate the best suitable (optimum) MCS for each data stream, or may be configured to communicate to the terminal device to use a default MCS.

A third exemplary option for the transmission configuration is to use the Transmit or Receiver diversity mode as transmission mode, also referred to as Tx Rx diversity mode. This transmission mode is typically considered by the network when continuing in MIMO mode is not possible and/or has too many drawbacks. Tx Rx diversity mode is a possibility if not all of the transmitter side antennas are obstructed by the user (i.e. are not in proximity with a body part of the user). In such case Tx Rx diversity configuration may be used instead of the MIMO mode configuration. The antennas in Tx Rx diversity mode will e.g. operate in Multiple In Single Out, MISO, mode, or in Single In Multiple Out, SIMO, mode. MISO mode may e.g. be 2×1 MISO or 4×1 MISO and SIMO mode my e.g. be 1×2 SIMO or 1×4 SIMO.

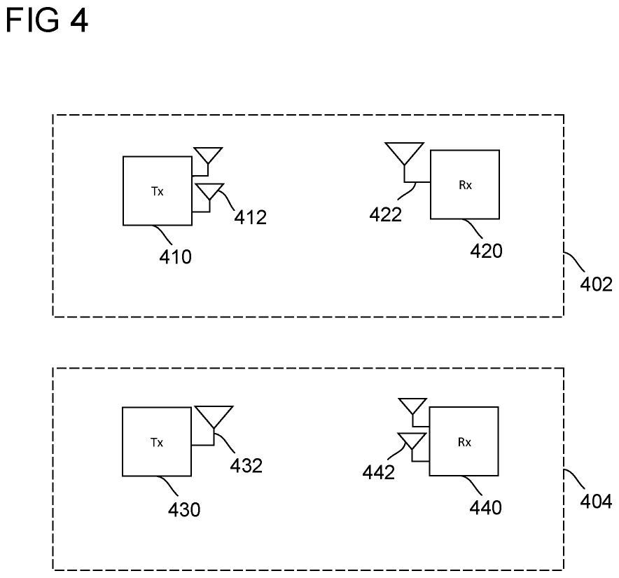

FIG. 4 illustrates the diversity reception modes MISO and SIMO. As illustrated in FIG. 4, in MISO mode 402, the transmitter 410 (e.g. terminal device 310) comprises two Tx antennas 412 (and, optionally, other Tx antennas not explicitly shown in FIG. 4) and the receiver 420 (e.g. base station 320) one Rx antenna 422. In SIMO mode 404, the transmitter 430 (e.g. terminal device 310) comprises one Tx antenna 432 and the receiver 440 (e.g. base station 320) comprises two Rx antennas 442 (and, optionally, other Rx antennas not explicitly shown in FIG. 4).

MISO and SIMO modes have the advantages of improving link performance, reducing the BER, working at a low Signal to Noise Ratio, SNR and only consuming a moderate amount of power. In comparison, MIMO mode consumes more power and only works at a high SNR and in low link correlation conditions. However, both MISO and SIMO modes provide a lower data throughput than MIMO mode.

A fourth exemplary option for the transmission configuration is to switch off one or more obstructed antennas. This may mean switching transmission mode from e.g. 8×8 MIMO to 4×4 MIMO or 2×2 MIMO, or switching to single antenna transmission mode (also referred to as Single In Single Out, SISO). Single antenna transmission mode will typically be selected when both MIMO and Tx Rx diversity modes are not possible and/or have too many drawbacks, e.g. because of a high reduction in the Tx power value of the obstructed antennas. The network then determines the best suited (optimal) MCS.

In the example of FIG. 2, switching off the obstructed antenna 212 means switching transmission modes from 2×2 MIMO to single antenna mode. In this case, the Tx power of the remaining transmitter antenna 214 may be increased, e.g. increased by the same amount as the Tx power of transmitter antenna 212. The network then determines the optimal MCS for single antenna mode. Typically, the MCS will be increased in order to achieve a higher data throughput via wireless channels 202 and 204. It should be noted that in case the terminal device was already operating in single antenna mode, the determined transmission configuration may only contain the new (optimal) MCS. It should further be noted that the increase in Tx power of antenna 214 does not affect SAR safety, since the antenna is not in the proximity of a human body part.

Table 2 below shows an exemplary MCS Index. As can be seen in Table 2, typically, the MCS index is higher when the transmit power is higher, and the MCS index is lower when the transmit power is lower.

TABLE 2
Exemplary MCS Index

| MCS Index | Modulation | Code Rate | Data Rate (Mbit/s) |
|---|---|---|---|
| 0 | π/2 BPSK | 1/2 | 27.5 |
| 1 | π/2 BPSK | 1/2 | 385.0 |
| 2 | π/2 BPSK | 1/2 | 770.0 |
| 3 | π/2 BPSK | 5/8 | 962.5 |
| 4 | π/2 BPSK | 3/4 | 1155.0 |
| 5 | π/2 BPSK | 13/16 | 1251.25 |
| 6 | π/2 QPSK | 1/2 | 1540.0 |
| 7 | π/2 QPSK | 5/8 | 1925.0 |
| 8 | π/2 QPSK | 3/4 | 2310.0 |
| 9 | π/2 QPSK | 13/16 | 2502.5 |
| 10 | π/2 16 QAM | 1/2 | 3080.0 |
| 11 | π/2 16 QAM | 5/8 | 3850.0 |

The advantages and disadvantages (power performance trade-offs) of the different transmission modes are resumed in Table 3 below.

TABLE 3
Power performance trade-offs for the different transmission modes

| SISO | MISO | SIMO | MIMO |
|---|---|---|---|
| (−) offers low | (−) offers low | (−) offers low | (−) consumes |
| throughput | throughput | throughput | more power |
| | | | (−) works at high |
| | | | SNR, low link |
| | | | correlation |
| | | | conditions |
| (+) requires | (+) improve link | (+) improve link | (+) offers high |
| low power | performance/ | performance/ | throughput |
| | reduces BER | reduces BER | |
| | (+) works at low | (+) works at low | |
| | SNR | SNR | |
| | (+) consumes | (+) consumes | |
| | moderate power | moderate power | |

As an alternative, the terminal device may be configured to fall back to a default transmission configuration when one or more of its transmitter antennas are in a SAR limiting scenario. The terminal device may be configured to indicate through direct or indirect messaging to the network that it is in a SAR limiting scenario, and both the terminal device and the network may be configured to move to a predefined and known default transmission configuration when the terminal device is in a SAR limiting scenario. The default transmission configuration may e.g. be a diversity mode (e.g. transmission mode 2 in Table 1) and MSC-1 or MSC-2.

After the network has determined the new (optimal) transmission configuration (transmission and MCS) for the terminal device, it instructs the terminal device to reconfigure to the determined transmission configuration.

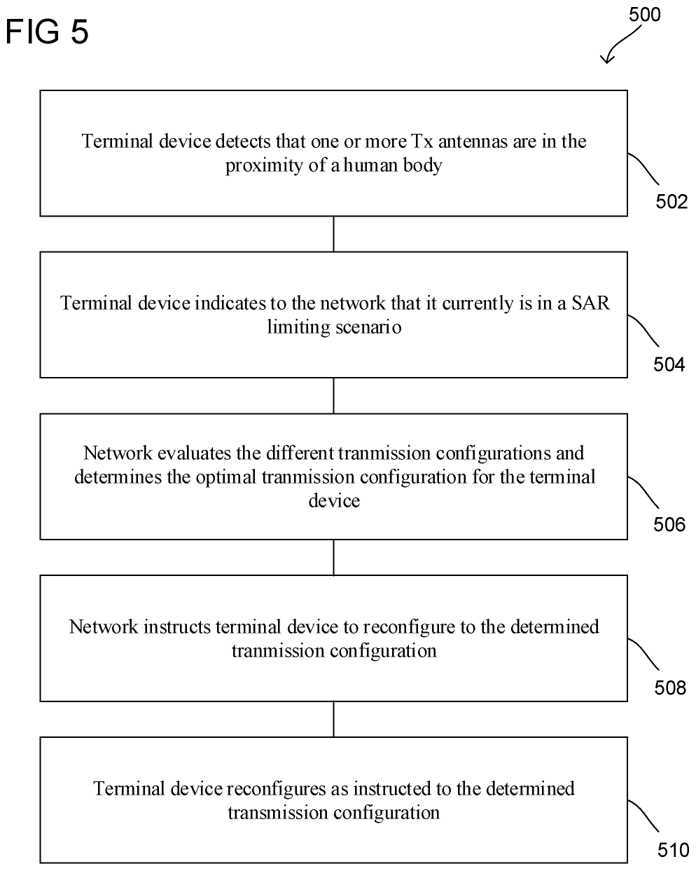

FIG. 5 shows an exemplary flowchart 500 of a method to (re-)configure a terminal device in a SAR limiting scenario.

In 502, the terminal device detects that one or more of its transmit antennas are in proximity of a human body. The terminal device then adjusts the Tx power of the obstructed one or more antennas in order to comply with the (applicable) SAR regulations.

In 504, the terminal device indicates to the network that it currently is in a SAR limiting scenario either indirectly via an already existing network message with modified parameters or unused bits or directly via a (new) dedicated message. The information sent to the network indicates at least which antennas are in a SAR limiting scenario and usually also indicates the total number of obstructed antennas and by how much their Tx power has been adjusted and/or their current Tx power level. It may further also indicate the maximum and/or the usual power level of the Tx antennas.

In 506, the network evaluates the performance gains of the different transmission configurations options. The network then determines the optimal transmission configuration for the terminal device in the current SAR limiting scenario. Assuming that the previous transmission configuration of the terminal device was n₁×n₂ MIMO mode, some of the options considered by the network will for example be:
(1) New MIMO mode with different configurations: e.g. omitting the obstructed antennas (e.g. changing from 8×8 MIMO to 4×4 MIMO) or redistributing the total Tx power value differently among the obstructed and non-obstructed antennas and increasing or decreasing the MCS index for the different MIMO streams;
(2) Single antenna mode: switching from MIMO mode to single antenna mode with the optimal MCS;
(3) Tx or Rx diversity mode: instead of MIMO a diversity mode such as e.g. SIMO or MISO (if necessary, with an adjusted MCS) may be used.

In 508, the network sends a message/notification to the terminal device instructing the device to reconfigure to the new transmission configuration determined in 506. The transmission configuration includes e.g. the transmission mode and MCS. It may also optionally include the transmission power.

In 510, the terminal device reconfigures to the received network determined transmission configuration. After reconfiguring, the terminal device may optionally notify the network that it has reconfigured as instructed (not shown in FIG. 5).

This method of reconfiguring a terminal device provides the optimum data throughput and radio link in SAR limiting scenarios. It further also reduces the BER and improves the overall user experience while guaranteeing SAR safety.

As an alternative to the method of FIG. 5, whenever the terminal device is in a SAR limiting scenario, it may be configured to notify the network (directly or indirectly) and both the terminal device and the network may be configured to move to a predefined default configuration with a default transmission mode (e.g. a diversity mode, e.g. transmission mode 2 in Table 1) and a default MCS (e.g. MCS-1 or MCS-2).

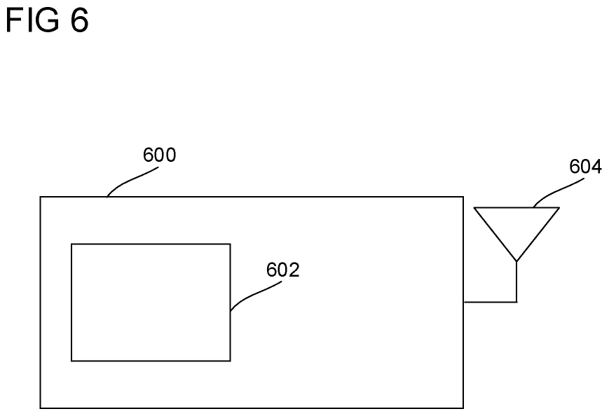

FIG. 6 illustrates an exemplary mobile radio terminal device 600 according to some aspects. As shown in FIG. 6, the mobile radio terminal device 600 includes a processor 602 configured to receive an information that one or more antennas 604 of the mobile radio terminal device 600 are in a proximity of a human body part of a user of the mobile radio terminal device, modify a transmission configuration of the mobile radio terminal device based on the received information, and generate a message representing the changed transmission configuration.

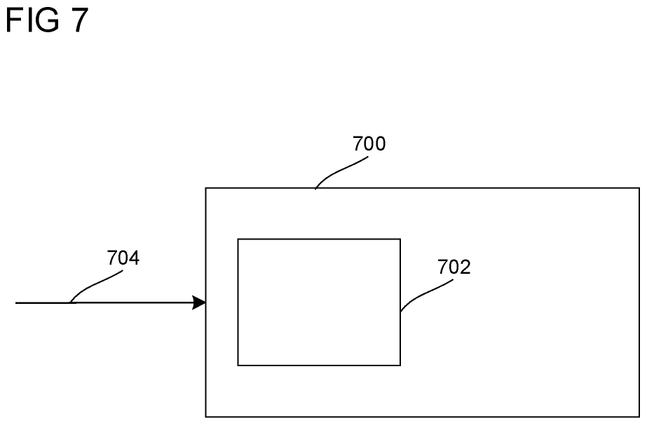

FIG. 7 illustrates an exemplary communication device according to some aspects. As shown in FIG. 7, a communication device 700 includes a processor 702 configured to receive a message 704 representing a changed transmission configuration of a mobile radio terminal device; and determine, based on the received message, a new transmission configuration for the mobile radio terminal device.

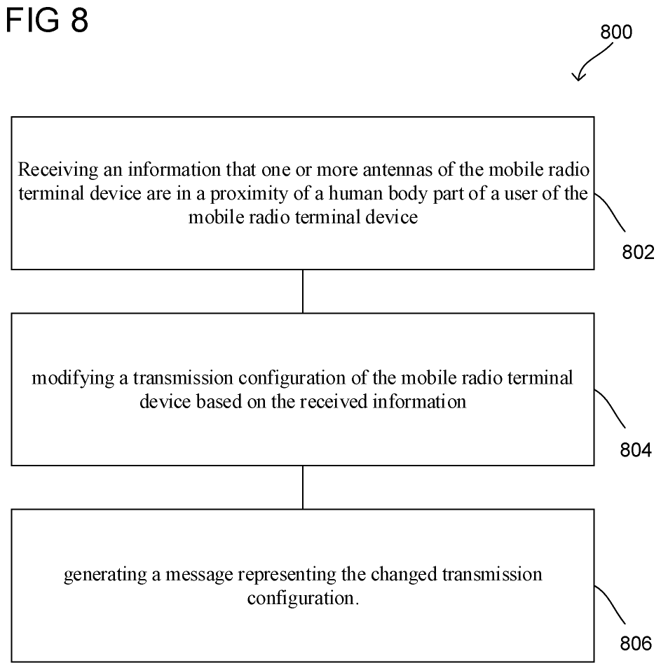

FIG. 8 shows a flowchart illustrating a method 800 of configuring a mobile radio terminal device such as e.g. terminal device 102 illustrated in FIG. 1, terminal device 210 illustrated in FIG. 2, terminal device 310 illustrated in FIG. 3 or mobile radio terminal device 600 illustrated in FIG. 6. As shown in FIG. 8, the method 800 of configuring a radio mobile terminal includes receiving 802 an information that one or more antennas of the mobile radio terminal device are in a proximity of a human body part of a user of the mobile radio terminal device, modifying 804 a transmission configuration of the mobile radio terminal device based on the received information, and generating 806 a message representing the changed transmission configuration.

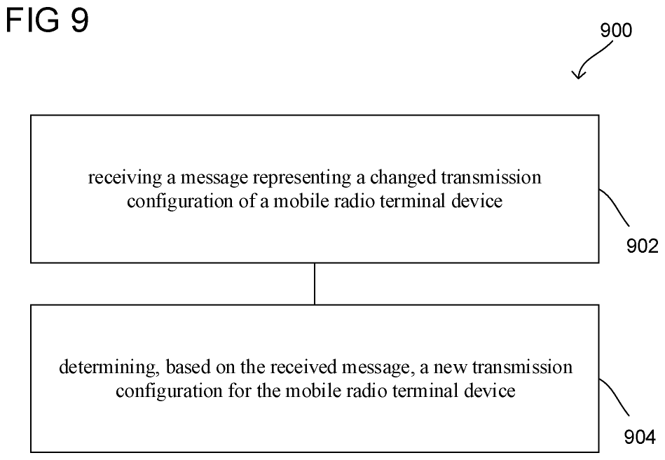

FIG. 9 shows a flowchart illustrating a method 900 of configuring a mobile radio terminal device (such as e.g. terminal device 102 illustrated in FIG. 1, terminal device 210 illustrated in FIG. 2, terminal device 310 illustrated in FIG. 3 or mobile radio terminal device 600 illustrated in FIG. 6) by a communication device (such as e.g. communication device 700) according to some aspects. As shown in FIG. 9, the method 900 of configuring a mobile radio terminal device by a communication device includes receiving 902 a message representing a changed transmission configuration of a mobile radio terminal device and determining 904, based on the received message, a new transmission configuration for the mobile radio terminal device.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

The following examples disclose various aspects of this disclosure:

Example 1 is a mobile radio terminal device. The mobile radio terminal device may include a processor configured to receive an information that one or more antennas of the mobile radio terminal device are in a proximity of a human body part of a user of the mobile radio terminal device, modify a transmission configuration of the mobile radio terminal device based on the received information, and generate a message representing the changed transmission configuration.

In Example 2, the subject-matter of Example 1 can optionally include that the mobile radio terminal device includes a transmitter configured to transmit the message to a communication device.

In Example 3, the subject-matter of Example 2 can optionally include that the message representing the changed transmission configuration is integrated into a regularly transmitted message to the communication device.

In Example 4, the subject-matter of Example 3 can optionally include that the message representing the changed transmission configuration is integrated into the Uplink Control Information, UCI.

In Example 5, the subject-matter of any one of Example 3 or 4 can optionally include that the message representing the changed transmission configuration is integrated into an existing message by using unused bits and/or by changing parameter values in the existing message.

In Example 6, the subject-matter of any one of Examples 1 to 5 can optionally include that the communication device is a base station or a mobile radio network device or a wireless access point (e.g. wireless access node).

In Example 7, the subject-matter of any one of Examples 1 to 6 can optionally include that the transmission configuration includes at least one of: a transmission mode, a transmission power, a modulation scheme, or a coding scheme.

In Example 8, the subject-matter of any one of Examples 1 to 7 can optionally include that the processor is configured to determine whether a regulation for an allowed specific absorption rate, SAR, level is fulfilled, and to change the transmission configuration in case the regulation is not fulfilled.

In Example 9, the subject-matter of any one of Examples 1 to 8 can optionally include that the mobile radio terminal device includes a plurality of antennas.

In Example 10, the subject-matter of any one of Examples 1 to 9 can optionally include that the processor is configured to determine whether the modified transmission configuration changes (e.g. reduces) the power level in an antenna of the mobile radio terminal device in a proximity of a human body part of a user of the mobile radio terminal device, to determine whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and to instruct to redistribute (if it has been determined possible) the power level of the antenna in a proximity of a human body part of a user to the one or more antennas not in a proximity of a human body part of a user.

In Example 11, the subject-matter of any one of Examples 1 to 10 can optionally include that the processor is configured to receive a network determined transmission configuration for the mobile radio terminal device, and modify the transmission configuration of the communication device in accordance with the received network determined transmission configuration.

In Example 12, the subject-matter of Example 11 can optionally include that the received network determined transmission configuration includes at least one of: a transmission mode, a transmission power, a modulation scheme, and a coding scheme.

In Example 13, the subject-matter of Example 12 can optionally include that the received network determined transmission configuration includes a transmission mode, wherein the transmission mode is one of the following: Multiple In Multiple Out (MIMO) mode, asymmetrical MIMO mode, Single In Multiple Out (SIMO) mode, Multiple In Single Out (MISO) mode, Transmit Receive diversity mode, and single antenna mode.

Example 14 is a communication device. The communication device may include a processor configured to receive a message representing a changed transmission configuration of a mobile radio terminal device, and determine, based on the received message, a new transmission configuration for the mobile radio terminal device.

In Example 15, the subject-matter of Example 14 can optionally include that the communication device includes a transmitter configured to transmit the determined transmission configuration to a mobile radio terminal device.

In Example 16, the subject-matter of any one of Examples 14 or 15 can optionally include that the communication device is a base station or a mobile radio network device or a wireless access point.

In Example 17, the subject-matter of Example 16 can optionally include that the communication device is an gNodeB, eNodeB, NodeB or a Base Transceiver Station.

In Example 18, the subject-matter of any one Example 14 to 17 can optionally include that the new transmission configuration is determined based on power and/or performance gains.

In Example 19, the subject-matter of any one Example 14 to 18 can optionally include that the received transmission configuration includes at least one of: a transmission mode, a transmission power, a modulation scheme, and a coding scheme.

In Example 20, the subject-matter of any one of Examples 14 to 19 can optionally include that the processor is configured to determine whether the changed transmission configuration changes (e.g. reduces) the power level in an antenna of the mobile radio terminal device in a proximity of a human body part of a user of the mobile radio terminal device, to determine whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and to instruct to redistribute (if it has been determined possible) the power level of the antenna in a proximity of a human body part of a user to the one or more antennas not in a proximity of a human body part of a user.

In Example 21, the subject-matter of any one Example 14 to 20 can optionally include that the determined transmission configuration includes at least one of: a transmission mode, a transmission power, a modulation scheme, and a coding scheme.

Example 22 is a method of configuring a mobile radio terminal device. The method may include receiving an information that one or more antennas of the mobile radio terminal device are in a proximity of a human body part of a user of the mobile radio terminal device, modifying a transmission configuration of the mobile radio terminal device based on the received information, and generating a message representing the changed transmission configuration.

In Example 23, the subject-matter of Example 22 can optionally include transmitting the generated message representing the changed transmission configuration to a communication device.

In Example 24, the subject-matter of Example 23 can optionally include that the message representing the changed transmission configuration is integrated into a regularly transmitted message to the communication device.

In Example 25, the subject-matter of Example 24 can optionally include that the message representing the changed transmission configuration is integrated into the Uplink Control Information, UCI.

In Example 26, the subject-matter of any one of Example 24 or 25 can optionally include that the message representing the changed transmission configuration is integrated into an existing message by using unused bits and/or by changing parameter values in the existing message.

In Example 27, the subject-matter of any one of Examples 22 to 26 can optionally include that the communication device is a base station or a mobile radio network device or a wireless access point.

In Example 28, the subject-matter of any one of Examples 22 to 27 can optionally include that the transmission configuration includes at least one of: a transmission mode, a transmission power, a modulation scheme, or a coding scheme.

In Example 29, the subject-matter of any one of Examples 22 to 28 can optionally include determining whether a regulation for an allowed specific absorption rate, SAR, level is fulfilled, and changing the transmission configuration in case the regulation is not fulfilled.

In Example 30, the subject-matter of any one of Examples 22 to 29 can optionally include determining whether the modified transmission configuration changes (e.g. reduces) the power level in an antenna of the mobile radio terminal device in a proximity of a human body part of a user of the mobile radio terminal device, and determining whether the power level of said antenna (the antenna of the mobile radio terminal device in a proximity of a human body part) can be redistributed to one or more other antennas of the mobile radio terminal device which are not in a proximity of a human body part of a user of the mobile radio terminal device.

In Example 31, the subject-matter of any one of Examples 22 to 30 can optionally include receiving a transmission configuration for the mobile radio terminal device determined by a communication device, and modifying the transmission configuration of the mobile radio terminal device in accordance with the received transmission configuration.

In Example 32, the subject-matter of Example 31 can optionally include that the received determined transmission configuration includes at least one of: a transmission mode, a transmission power, a modulation scheme, and a coding scheme.

In Example 33, the subject-matter of Example 32 can optionally include that the received determined transmission configuration includes a transmission mode, wherein the transmission mode is one of the following: Multiple In Multiple Out (MIMO) mode, asymmetrical MIMO mode, Single In Multiple Out (SIMO) mode, Multiple In Single Out (MISO) mode, Transmit Receive diversity mode, and single antenna mode.

Example 34 is a method of configuring a mobile radio terminal device by a communication device. The method may include receiving a message representing a changed transmission configuration of a mobile radio terminal device, and determining, based on the received message, a new transmission configuration for the mobile radio terminal device.

In Example 35, the subject-matter of Example 34 can optionally include transmitting the determined transmission configuration to the mobile radio terminal device.

In Example 36, the subject-matter of any one of Examples 34 or 35 can optionally include that the communication device is a base station or a mobile radio network device or a wireless access point.

In Example 37, the subject-matter of Example 36 can optionally include that the communication device is an gNodeB, eNodeB, NodeB or a Base Transceiver Station.

In Example 38, the subject-matter of any one Example 34 to 37 can optionally include that the new transmission configuration is determined based on power and/or performance gains.

In Example 39, the subject-matter of any one Example 34 to 38 can optionally include that the received transmission configuration includes at least one of: a transmission mode, a transmission power, a modulation scheme, and a coding scheme.

In Example 40, the subject-matter of any one of Examples 34 to 39 can optionally include determining whether the modified transmission configuration changes (e.g. reduces) the power level in an antenna of the mobile radio terminal device in a proximity of a human body part of a user of the mobile radio terminal device, determining whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and instructing the mobile radio terminal device (if it has been determined possible) to redistribute the power level of the antenna in a proximity of a human body part of a user to the one or more antennas not in a proximity of a human body part of a user.

In Example 41, the subject-matter of any one Example 34 to 40 can optionally include that the determined transmission configuration includes at least one of: a transmission mode, a transmission power, a modulation scheme, and a coding scheme.

Example 42 is a non-transitory computer readable medium. The non-transitory computer-readable medium may include instructions which, when executed, implements a method of configuring a mobile radio terminal device, wherein the method includes receiving an information that one or more antennas of the mobile radio terminal device are in a proximity of a human body part of a user of the mobile radio terminal device, modifying a transmission configuration of the mobile radio terminal device based on the received information, and generating a message representing the changed transmission configuration.

In Example 43, the subject-matter of Example 42 can optionally include instructions which, when executed, implement transmitting the generated message representing the changed transmission configuration to a communication device.

In Example 44, the subject-matter of Example 43 can optionally include that the message representing the changed transmission configuration is integrated into a regularly transmitted message to the communication device.

In Example 45, the subject-matter of Example 44 can optionally include that the message representing the changed transmission configuration is integrated into the Uplink Control Information, UCI.

In Example 46, the subject-matter of any one of Example 44 or 45 can optionally include that the message representing the changed transmission configuration is integrated into an existing message by using unused bits and/or by changing parameter values in the existing message.

In Example 47, the subject-matter of any one of Examples 42 to 46 can optionally include that the communication device is a base station or a mobile radio network device or a wireless access point.

In Example 48, the subject-matter of any one of Examples 42 to 47 can optionally include that the transmission configuration includes at least one of: a transmission mode, a transmission power, a modulation scheme, or a coding scheme.

In Example 49, the subject-matter of any one of Examples 42 to 48 can optionally include instructions which, when executed, implement determining whether a regulation for an allowed specific absorption rate, SAR, level is fulfilled, and changing the transmission configuration in case the regulation is not fulfilled.

In Example 50, the subject-matter of any one of Examples 42 to 49 can optionally include instructions which, when executed, implement determining whether the modified transmission configuration changes (e.g. reduces) the power level in an antenna of the mobile radio terminal device in a proximity of a human body part of a user of the mobile radio terminal device, determining whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and instructing the mobile radio terminal device to redistribute (if it has been determined possible) the power level of the antenna in a proximity of a human body part of a user to the one or more antennas not in a proximity of a human body part of a user.

In Example 51, the subject-matter of any one of Examples 42 to 50 can optionally include instructions which, when executed, implement receiving a transmission configuration for the mobile radio terminal device determined by a communication device, and modifying the transmission configuration of the mobile radio terminal device in accordance with the received transmission configuration.

In Example 52, the subject-matter of Example 51 can optionally include that the received determined transmission configuration includes at least one of: a transmission mode, a transmission power, a modulation scheme, and a coding scheme.

In Example 53, the subject-matter of Example 52 can optionally include that the received determined transmission configuration includes a transmission mode, wherein the transmission mode is one of the following: Multiple In Multiple Out (MIMO) mode, asymmetrical MIMO mode, Single In Multiple Out (SIMO) mode, Multiple In Single Out (MISO) mode, Transmit Receive diversity mode, and single antenna mode.

Example 54 is a non-transitory computer readable medium. The non-transitory computer-readable medium may include instructions which, when executed, implements a method of configuring a mobile radio terminal device by a communication device, wherein the method includes receiving a message representing a changed transmission configuration of a mobile radio terminal device, and determining, based on the received message, a new transmission configuration for the mobile radio terminal device.

In Example 55, the subject-matter of Example 54 can optionally include instructions which, when executed, implement transmitting the determined transmission configuration to the mobile radio terminal device.

In Example 56, the subject-matter of any one of Examples 54 or 55 can optionally include that the communication device is a base station or a mobile radio network device or a wireless access point.

In Example 57, the subject-matter of Example 56 can optionally include that the communication device is an gNodeB, eNodeB, NodeB or a Base Transceiver Station.

In Example 58, the subject-matter of any one Example 54 to 57 can optionally include instructions which, when executed, implement determining the new transmission configuration based on power and/or performance gains.

In Example 59, the subject-matter of any one Example 54 to 58 can optionally include that the received transmission configuration includes at least one of: a transmission mode, a transmission power, a modulation scheme, and a coding scheme.

In Example 60, the subject-matter of any one of Examples 54 to 59 can optionally include instructions which, when executed, implement determining whether the modified transmission configuration changes (e.g. reduces) the power level in an antenna of the mobile radio terminal device in a proximity of a human body part of a user of the mobile radio terminal device, determining whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and instructing the mobile radio terminal device to redistribute (if it has been determined possible) the power level of the antenna in a proximity of a human body part of a user to the one or more antennas not in a proximity of a human body part of a user.

In Example 61, the subject-matter of any one Example 54 to 60 can optionally include that the determined transmission configuration includes at least one of: a transmission mode, a transmission power, a modulation scheme, and a coding scheme.

Example 62 is a device for configuring a mobile radio terminal device. The device may include means for receiving an information that one or more antennas of the mobile radio terminal device are in a proximity of a human body part of a user of the mobile radio terminal device, means for modifying a transmission configuration of the mobile radio terminal device based on the received information, and means for generating generate a message representing the changed transmission configuration.

In Example 63, the subject-matter of Example 62 can optionally include that the device includes means for transmitting the message to a communication device.

In Example 64, the subject-matter of Example 63 can optionally include that the message representing the changed transmission configuration is integrated into a regularly transmitted message to the communication device.

In Example 65, the subject-matter of Example 64 can optionally include that the message representing the changed transmission configuration is integrated into the Uplink Control Information, UCI.

In Example 66, the subject-matter of any one of Example 64 or 65 can optionally include that the message representing the changed transmission configuration is integrated into an existing message by using unused bits and/or by changing parameter values in the existing message.

In Example 67, the subject-matter of any one of Examples 62 to 66 can optionally include that the communication device is a base station or a mobile radio network device or a wireless acess point.

In Example 68, the subject-matter of any one of Examples 62 to 67 can optionally include that the transmission configuration includes at least one of: a transmission mode, a transmission power, a modulation scheme, or a coding scheme.

In Example 69, the subject-matter of any one of Examples 62 to 68 can optionally include that the device includes means for determining whether a regulation for an allowed specific absorption rate, SAR, level is fulfilled, and means for changing the transmission configuration in case the regulation is not fulfilled.

In Example 70, the subject-matter of any one of Examples 62 to 69 can optionally include means for determining whether the modified transmission configuration changes (e.g. reduces) the power level in an antenna of the mobile radio terminal device in a proximity of a human body part of a user of the mobile radio terminal device, means for determining whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and means for instructing to redistribute (if it has been determined possible) the power level of the antenna in a proximity of a human body part of a user to the one or more antennas not in a proximity of a human body part of a user.

In Example 71, the subject-matter of any one of Examples 62 to 70 can optionally include that the device includes means for receiving a network determined transmission configuration for the mobile radio terminal device, and means for modifying the transmission configuration of the communication device in accordance with the received network determined transmission configuration.

In Example 72, the subject-matter of Example 71 can optionally include that the received network determined transmission configuration includes at least one of: a transmission mode, a transmission power, a modulation scheme, and a coding scheme.

In Example 73, the subject-matter of Example 72 can optionally include that the received network determined transmission configuration includes a transmission mode, wherein the transmission mode is one of the following: Multiple In Multiple Out (MIMO) mode, asymmetrical MIMO mode, Single In Multiple Out (SIMO) mode, Multiple In Single Out (MISO) mode, Transmit Receive diversity mode, and single antenna mode.

Example 74 is a device for configuring a mobile radio terminal device. The device may include means for receiving a message representing a changed transmission configuration of a mobile radio terminal device, and means for determining, based on the received message, a new transmission configuration for the mobile radio terminal device.

In Example 75, the subject-matter of Example 74 can optionally include that the device includes means for transmitting the determined transmission configuration to the mobile radio terminal device.

In Example 76, the subject-matter of any one of Examples 74 or 75 can optionally include that the device is a base station or a mobile radio network device or a wireless access point.

In Example 77, the subject-matter of Example 76 can optionally include that the device is an gNodeB, eNodeB, NodeB or a Base Transceiver Station.

In Example 78, the subject-matter of any one Example 74 to 77 can optionally include that the new transmission configuration is determined based on power and/or performance gains.

In Example 79, the subject-matter of any one Example 74 to 78 can optionally include that the received transmission configuration includes at least one of: a transmission mode, a transmission power, a modulation scheme, and a coding scheme.

In Example 80, the subject-matter of any one of Examples 74 to 79 can optionally include means for determining whether the modified transmission configuration changes (e.g. reduces) the power level in an antenna of the mobile radio terminal device in a proximity of a human body part of a user of the mobile radio terminal device, means for determining whether the power level of said antenna (the antenna of the mobile radio terminal device in a proximity of a human body part) can be redistributed to one or more other antennas of the mobile radio terminal device which are not in a proximity of a human body part of a user of the mobile radio terminal device, and means for instructing to redistribute (if it has been determined possible) the power level of the antenna in a proximity of a human body part of a user to the one or more antennas not in a proximity of a human body part of a user.

In Example 81, the subject-matter of any one Example 74 to 80 can optionally include that the determined transmission configuration includes at least one of: a transmission mode, a transmission power, a modulation scheme, and a coding scheme.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A mobile radio terminal device comprising:
a processor configured to:
receive information that one or more antennas of the mobile radio terminal device are in proximity of a human body part of a user of the mobile radio terminal device;
modify a transmission configuration of the mobile radio terminal device based on the received information; and
generate a message representing the changed transmission configuration.

2. The mobile radio terminal device of claim 1, further comprising:
a transmitter configured to transmit the message to a communication device.

3. The mobile radio terminal device of claim 2,
wherein the communication device is a base station or a mobile radio network device or a wireless access point.

4. The mobile radio terminal device of claim 1,
wherein the transmission configuration comprises at least one of:
a transmission mode;
a transmission power;
a modulation scheme; or
a coding scheme.

5. The mobile radio terminal device of claim 1,
wherein the processor is further configured to determine whether a regulation for an allowed specific absorption rate, SAR, level is fulfilled; and to change the transmission configuration in case the regulation is not fulfilled.

6. The mobile radio terminal device of claim 1,
wherein the processor is further configured to:
determine whether the modified transmission configuration changes the power level in an antenna of the mobile radio terminal device in proximity of a human body part of a user of the mobile radio terminal device;
determine whether the power level of said antenna can be redistributed to one or more other antennas of the mobile radio terminal device which are not in proximity of a human body part of a user of the mobile radio terminal device; and
instruct to redistribute the power level of the antenna in proximity of a human body part of a user to the one or more antennas not in proximity of a human body part of a user.

7. The mobile radio terminal device of claim 1,
wherein the processor is further configured to:
receive a network determined transmission configuration for the mobile radio terminal device; and
modify the transmission configuration of the mobile radio terminal device in accordance with the received network determined transmission configuration.

8. The mobile radio terminal device of claim 7,
wherein the received network determined transmission configuration comprises at least one of:
a transmission mode;
a transmission power;
a modulation scheme; or
a coding scheme.

9. The mobile radio terminal device of claim 8,
wherein the received network determined transmission configuration comprises a transmission mode;
wherein the transmission mode is one of:
Multiple In Multiple Out (MIMO) mode;
asymmetrical MIMO mode;
Single In Multiple Out (SIMO) mode;
Multiple In Single Out (MISO) mode;
Transmit Receive diversity mode; or
single antenna mode.

10. A communication device comprising:
a processor configured to:
receive a message representing a changed transmission configuration of a mobile radio terminal device; and
determine, based on the received message, a new transmission configuration for the mobile radio terminal device.

11. The communication device of claim 10, further comprising:
a transmitter configured to transmit the determined transmission configuration to the mobile radio terminal device.

12. The communication device of claim 10,
wherein the communication device is a base station or a mobile radio network device or a wireless access point.

13. The communication device of claim 10,
wherein the new transmission configuration is determined based on power performance gains.

14. The communication device of claim 10,
wherein the received transmission configuration comprises at least one of:
a transmission mode;
a transmission power;
a modulation scheme; or
a coding scheme.

15. The communication device of claim 10,
wherein the determined transmission configuration comprises at least one of:
a transmission mode;
a transmission power;
a modulation scheme; or
a coding scheme.

16. A non-transitory computer readable medium comprising instructions which, when executed, implement:
receiving an information that one or more antennas of the mobile radio terminal device are in proximity of a human body part of a user of the mobile radio terminal device;
modifying a transmission configuration of the mobile radio terminal device based on the received information; and
generating a message representing the changed transmission configuration.

17. The non-transitory computer readable medium of claim 16, further comprising instructions which, when executed, implement:
transmitting the generated message representing the changed transmission configuration to a communication device.

18. The non-transitory computer readable medium of claim 16,
wherein the received transmission configuration comprises at least one of:
a transmission mode;
a transmission power;
a modulation scheme; or
a coding scheme.

19. The non-transitory computer readable medium of claim 16, further comprising instructions which, when executed, implement:
determining whether a regulation for an allowed specific absorption rate, SAR, level is fulfilled, and
changing the transmission configuration in case the regulation is not fulfilled.

20. The non-transitory computer readable medium of claim 16, further comprising instructions which, when executed, implement:
determining whether the modified transmission configuration changes the power level in an antenna of the mobile radio terminal device in proximity of a human body part of a user of the mobile radio terminal device;
determining whether the power level of said antenna can be redistributed to one or more other antennas of the mobile radio terminal device which are not in proximity of a human body part of a user of the mobile radio terminal device; and
instructing the mobile radio terminal device to redistribute the power level of the antenna in proximity of a human body part of a user to the one or more antennas not in proximity of a human body part of a user.

21. A non-transitory computer readable medium comprising instructions which, when executed, implement:
receiving a message representing a changed transmission configuration of a mobile radio terminal device; and
determining, based on the received message, a new transmission configuration for the mobile radio terminal device.

22. The non-transitory computer readable medium of claim 21, further comprising instructions which, when executed, implement:
transmitting the determined transmission configuration to the mobile radio terminal device.

23. The non-transitory computer readable medium of claim 21, wherein the new transmission configuration is determined based on power performance gains.

24. The non-transitory computer readable medium of claim 21,
wherein the received transmission configuration comprises at least one of:
a transmission mode;
a transmission power;
a modulation scheme; or
a coding scheme.

25. The non-transitory computer readable medium of claim 21,
wherein the determined transmission configuration comprises at least one of:
a transmission mode;
a transmission power;
a modulation scheme; or
a coding scheme.
